(19) United States
(12) Patent Application Publication
(10) Pub. No.: US 2025/0062355 A1
(43) Pub. Date: Feb. 20, 2025

(54) METHOD FOR MANUFACTURING SELF-STANDING FILM FOR NEGATIVE-ELECTRODE OF LITHIUM SECONDARY BATTERY, AND SELF-STANDING FILM FOR NEGATIVE-ELECTRODE OF LITHIUM SECONDARY BATTERY

(71) Applicants: Hyundai Motor Company, Seoul (KR); Kia Corporation, Seoul (KR)

(72) Inventors: Byung Yong Lee, Anyang (KR); Dae Yang Oh, Hwaseong (KR); Hyun Jeong Kim, Suwon (KR)

(21) Appl. No.: 18/511,169

(22) Filed: Nov. 16, 2023

(30) Foreign Application Priority Data
Aug. 14, 2023 (KR) 10-2023-0106485

(51) Int. Cl. H01M 4/62; H01M 4/04; H01M 4/139; H01M 10/052

(52) U.S. Cl. CPC H01M 4/622; H01M 4/0435; H01M 4/139; H01M 10/052; H01M 2004/021; H01M 2004/027; H01M 2220/20

(57) ABSTRACT

A method for manufacturing a self-standing film for a negative-electrode of a lithium secondary battery includes performing a first film formation process using a composition for forming the negative-electrode of the lithium secondary battery to obtain a first negative-electrode active material layer, wherein the composition includes a negative-electrode active material, a conductive material, and a binder; pulverizing the first negative-electrode active material layer to obtain composite powders for formation of the negative-electrode as a pulverized product; and performing a second film formation process using the composite powders to obtain a second negative-electrode active material layer, wherein the binder includes a triblock copolymer having: a soft block derived from an aliphatic or cycloaliphatic diene-based monomer and having a rubber phase at room temperature; and a first hard block and a second hard block respectively connected to both ends of the soft block, and derived from an aromatic ring-containing ethylenically unsaturated monomer, and having a glass phase at room temperature. Further, the self-standing film for the negative-electrode manufactured using the method is provided.

### CROSS-REFERENCE TO RELATED APPLICATION

This application claims the benefit of priority to Korean Patent Application No. 10-2023-0106485, filed in the Korean Intellectual Property Office on Aug. 14, 2023, the entire contents of which are incorporated herein by reference.

### TECHNICAL FIELD

The present disclosure relates to a method for manufacturing a self-standing film for a negative-electrode of a lithium secondary battery using a binder including a triblock copolymer containing a soft block and hard blocks, and a self-standing film for a negative-electrode of a lithium secondary battery manufactured using the method.

### BACKGROUND

Lithium secondary batteries have been widely applied in the portable electronic device market since their first commercialization in the 1990s, and continue to receive attention as the most researched energy storage system. Because of the characteristics of the lithium secondary batteries such as high operation voltage, high energy density, low self-discharge rate, high rate performance, and long cycle stability, lithium secondary batteries meet the appropriate requirements as an energy source for electric vehicles.

Nevertheless, the lithium secondary batteries applied to the electric vehicles face three major issues: safety, operating time, and cost. Issues of the safety and the operating time may be solved through all-solid-state batteries, but the cost acts as a factor preventing the widespread application of the lithium secondary batteries. Thus, much research is being conducted to reduce the cost of the lithium secondary batteries.

Reducing energy consumption required for manufacturing the lithium secondary batteries or increasing an electrode thickness is one of the most effective ways to reduce the manufacturing cost of lithium secondary batteries. Conventional electrode manufacturing technology forms an electrode by casting a slurry in which an electrode active material, a polymer binder, and a conductive additive are mixed with each other in water or an organic solvent onto a current collector, and drying and pressing the cast slurry. The energy required to prepare the slurry and coat the slurry onto the current collector accounts for about 50% of the energy consumed in the entire manufacturing process. In order to reduce the manufacturing cost of the lithium secondary batteries, research has been conducted on a process for manufacturing the electrode in a dry manner without the solvent.

In this regard, a scheme for manufacturing, in a dry manner, a positive-electrode of a lithium secondary battery using polytetrafluoroethylene (PTFE) which has excellent adhesiveness has been proposed. However, PTFE has a low LUMO (lowest unoccupied molecular orbitals) level, and thus may easily accept electrons, and thus is electrochemically unstable in a negative potential environment. A carbyne which PTFE accepts the electrons to produce cannot withstand volume expansion and contraction during the charging and discharging process. Thus, the negative-electrode of the lithium secondary battery manufactured using the PTFE as a binder has a problem of poor cycle stability.

Accordingly, there is a need to develop a scheme for manufacturing, in a dry manner, a negative-electrode using a binder that is stable even at negative potential.

### SUMMARY

The present disclosure has been made to solve the above-mentioned problems occurring in the prior art while advantages achieved by the prior art are maintained intact.

In one aspect a method for manufacturing a self-standing film suitable for a negative-electrode of a lithium secondary battery is provided, the method comprising: a) forming a first electrode active film material using a composition that comprises i) a negative-electrode active material, ii) a conductive material, and iii) a binder; b) treating the first electrode active material to obtain composite powders; and c) forming a second electrode active film material using the composite powders, wherein the iii) binder comprises a triblock copolymer comprising: a) a soft block derived from an aliphatic or cycloaliphatic diene-based monomer and having a rubber phase at room temperature; and b) a first hard block and a second hard block respectively connected to ends of the soft block, and derived from an aromatic ring-containing ethylenically unsaturated monomer, and having a glass phase at the room temperature.

An aspect of the present disclosure provides a self-standing film for a negative-electrode of a lithium secondary battery manufactured using a binder including a triblock copolymer containing hard blocks that contribute to excellent mechanical properties and a flexible soft block, such that the binder strongly binds to a negative-electrode active material, and has good formability, and is stable even at a negative potential level, and has excellent tensile strength, and strongly binds to the negative-electrode active material and a conductive material to form a three-dimensional network, and provides a manufacturing method thereof, and provides a negative-electrode for a lithium secondary battery including the self-standing film, and provides a lithium secondary battery including the negative-electrode.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a method for manufacturing a self-standing film for a negative-electrode of a lithium secondary battery includes performing a first film formation process using a composition for forming the negative-electrode of the lithium secondary battery to obtain a first negative-electrode active material layer, wherein the composition includes a negative-electrode active material, a conductive material, and a binder; treating the first negative-electrode active material layer to obtain composite powders for formation of the negative-electrode as a pulverized product; and performing a second film formation process using the composite powders to obtain a second negative-electrode active material layer, wherein the binder includes a triblock copolymer having: a soft block derived from an aliphatic or cycloaliphatic diene-based monomer and having a rubber phase at room temperature; and a first hard block and a second hard block respectively connected to both ends of the soft block, and derived from an aromatic ring-containing ethylenically unsaturated monomer, and having a glass phase at the room temperature.

In an aspect, the composite powders as disclosed herein may include powder elements that each has an ellipsoid shape, and an average sphericity thereof is in a range of 0.6 to 0.8. In certain aspects, the composite powders comprise particles each having an average diameter (D₅₀) in a range of 100 μm to 300 μm.

In an aspect, the binder comprises particles having a spherical shape, and an average sphericity thereof is in a range of 0.8 to 1.0.

In an aspect, the binder of a self-standing film composition suitably comprises particles, each having an average diameter (D₅₀) in a range of 1 μm to 20 μm.

In an aspect, in a self-standing film composition, suitably each of first and second glass transition temperatures corresponding to the first hard block and the second hard block, respectively, is in a range of 50° C. to 120° C., wherein a third glass transition temperature corresponding to the soft block is in a range of −120° C. to −50° C.

In an aspect, in a self-standing film composition, suitably the soft block is derived from the aliphatic or cycloaliphatic diene-based monomer including at least one selected from a group consisting of butadiene-based monomer, pentadiene-based monomer, and hexadiene-based monomer.

In an aspect, in a self-standing film composition, suitably each of the first hard block and the second hard block is independently derived from the aromatic ring-containing ethylenically unsaturated monomer including at least one of a styrene-based monomer and an aromatic (meth)acrylic-based monomer.

In an aspect, in a self-standing film composition, suitably at least one of the of 1) forming a first electrode active film material and 2) forming a second electrode active film material includes calendaring. wherein the calendering is performed at a temperature equal to or higher than a first glass transition temperature and a second glass transition temperature corresponding to the first hard block and the second hard block, respectively.

In an aspect, provided is a negative electrode of a lithium secondary battery that includes the composition as described herein.

In an aspect, provided is a lithium secondary battery including the negative electrode as described herein.

In an aspect, provided is a vehicle including the lithium secondary battery as described herein.

As referred to herein, a rubber phase or state is above the T_{g}, (glass transition temperature) of the material, i.e. where the material may be in a more rubber state, and comparatively soft and flexible. Thus, when stated herein that the material forms a forming a rubbery phase at room temperature (e.g. 25° C.), the material may be above its glass transition temperature at room temperature (25° C.) and may in a comparatively rubbery or more flexible state.

As referred to herein, a glass phase or state is below the T_{g}, (glass transition temperature) of the material, and where the material may be in a more rigid or glassy configuration. Thus, when stated herein that the material forms a glass phase at room temperature (e.g. 25° C.), the material may be below its glass transition temperature at room temperature (25° C.) and may in a comparatively rigid or hardened state.

A term “all-solid-state battery” as used herein refers to a rechargeable secondary battery that includes an electrolyte in a solid state, e.g., gel or polymer (cured), which may include an ionomer and other electrolytic components for transferring ions between the electrodes of the battery. In certain aspect, a lithium secondary battery as referred to herein is an all-solid state battery.

The term “self-standing” as used herein includes that the film can be in the form of a sheet and can be handled as an independent sheet without the assistance of a substrate or support. Thus, the term “self-standing” may have the same meaning as “self-supporting”.

As referred to herein the term “block polymer” includes a polymer comrpising two or more chemically distinct regions or segments (referred to as “blocks”) typically joined in a linear manner, e.g. a polymer comprising chemically differentiated units which are joined (covalently bonded) end-to-end with respect to polymerized functionality, rather than in pendent or grafted fashion. In one aspect, a block polymer may comprise (i) a first polymer block comprising at least 5, 10, 20 or 30 first repeating units, and (ii) a second polymer block comprising at least 5, 10, 20 or 30 second repeating units.

As referred to herein, the terms “soft block” and “hard block” indicate that the respective polymer units or portions differ in e.g. in structure and one or more properties. In certain aspects, the soft block may have a lower glass transition temperature or melting temperature (e.g. below room temperature) than a hard bloc. (which may have a glass transition temperature or melting temperature higher (such as above room temperature) than the applicator temperature of the formed block copolymer material. In certain embodiments, the Tg of hard and soft blocks may differ by e.g. up to or more than e.g. 3° C., 5° C., 10° C., 20° C. or 30° C.

According to another aspect of the present disclosure, a self-standing film for a negative-electrode of a lithium secondary battery includes a negative-electrode active material layer including a plurality of domains of a negative-electrode active material, a plurality of domains of a conductive material, and a binder, wherein the binder includes a triblock copolymer having: a soft block derived from an aliphatic or cycloaliphatic diene-based monomer and having a rubber phase at room temperature; and a first hard block and a second hard block respectively connected to both ends of the soft block, derived from an aromatic ring-containing ethylenically unsaturated monomer, and having a glass phase at the room temperature, wherein the binder has a discontinuous pillar connecting one domain of the active material or one domain of the conductive material to another domain of the active material or another domain of the conductive material, wherein the binder has an average width perpendicular to a longitudinal direction thereof in a range of 10 nm inclusive to 150 nm inclusive.

According to still another aspect of the present disclosure, a negative-electrode for a lithium secondary battery includes a current collector; and a self-standing film for the negative-electrode of the lithium secondary battery disposed on the current collector, wherein the self-standing film includes the self-standing film for the negative-electrode of the lithium secondary battery as defined above.

According to still another aspect of the present disclosure, a lithium secondary battery includes the negative-electrode for the lithium secondary battery; a positive-electrode for the lithium secondary battery; and an electrolyte.

Other aspects of the invention are disclosed infra.

### BRIEF DESCRIPTION OF THE DRAWINGS

The above and other objects, features and advantages of the present disclosure will be more apparent from the following detailed description taken in conjunction with the accompanying drawings:

FIG. 1 is a schematic diagram showing an internal structure of a binder included in a self-standing film for a negative-electrode of a lithium secondary battery according to one embodiment of the present disclosure;

FIG. 2A is a schematic illustration of a method for manufacturing a self-standing film for a negative-electrode of a lithium secondary battery according to one embodiment of the present disclosure;

FIG. 2B is a diagram schematically showing a binder change mechanism during a manufacturing process of a self-standing film for a negative-electrode of a lithium secondary battery according to one embodiment of the present disclosure;

FIG. 3A and FIG. 3B show SEM images of a mixed powder formed after pulverization during a manufacturing process of a self-standing film for a negative-electrode of a lithium secondary battery according to Present Example 1;

FIG. 3C shows a particle size analysis result of a mixed powder particle formed after pulverization during the manufacturing process of the self-standing film for the negative-electrode of the lithium secondary battery according to Present Example 1;

FIG. 4A to FIG. 4C show SEM images of the self-standing film for the negative-electrode of the lithium secondary battery according to Present Example 1;

FIG. 4D to FIG. 4F show SEM images of a self-standing film for a negative-electrode of a lithium secondary battery according to Reference Example 1;

FIG. 4G schematically shows a network structure composed of a binder and a negative-electrode active material or a conductive material in a self-standing film for a negative-electrode of a lithium secondary battery;

FIG. 5A shows a result of an experiment evaluating electrolyte stability of Present Example 1;

FIG. 5B shows a result of an experiment evaluating electrolyte stability of Reference Example 1;

FIG. 6A shows a result of evaluating a tensile strength of the self-standing film for the negative-electrode according to each of Present Example 1 to Present Example 3 and Reference Example 1.

FIG. 6B and FIG. 6C show a flexibility evaluation experiment of the self-standing film for the negative-electrode according to Present Example 1; and

FIG. 7 shows a performance evaluation result of a lithium secondary battery according to each of Present Example 4 and Reference Example 4.

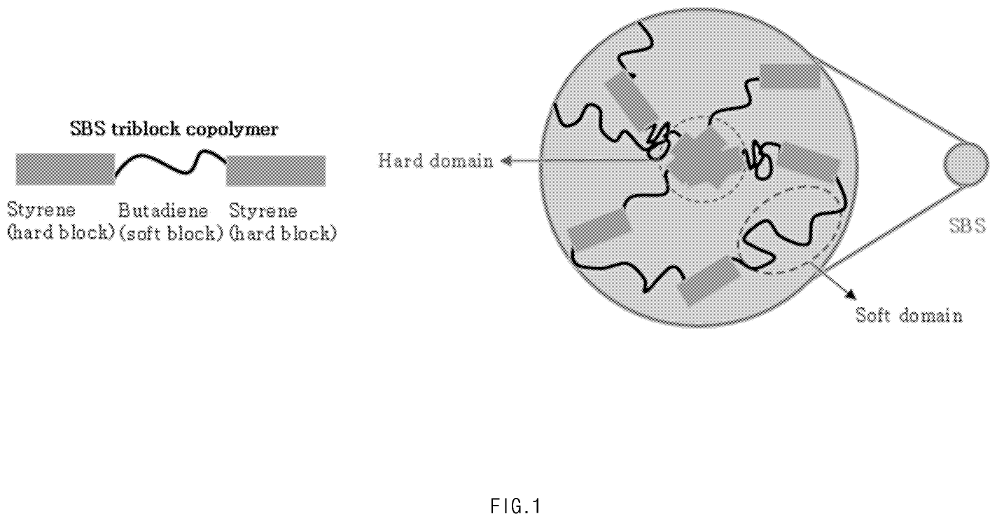

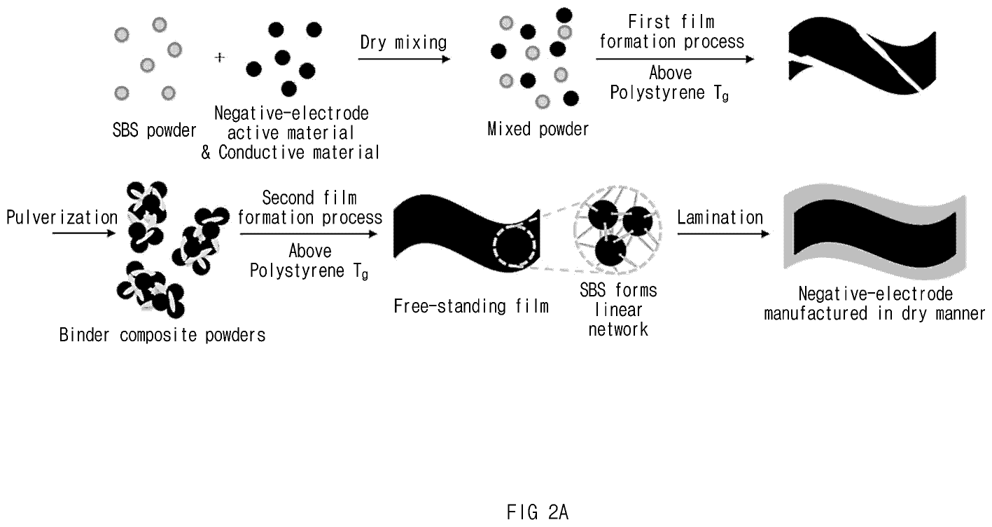

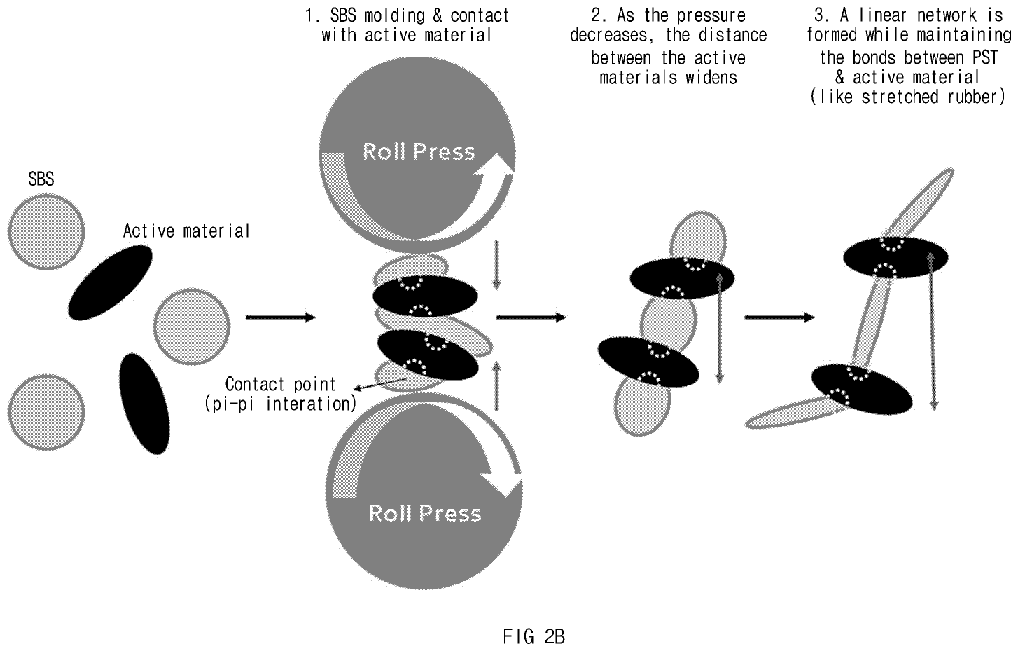

### DETAILED DESCRIPTION

Above objectives, other objectives, features, and advantages of the present disclosure will be readily understood from the following preferred embodiments associated with the accompanying drawings. However, the present disclosure is not limited to the embodiments described herein and may be embodied in other forms. The embodiments described herein are provided so that the disclosure can be made thorough and complete and that the spirit of the present disclosure can be fully conveyed to those skilled in the art. Throughout the drawings, like elements are denoted by like reference numerals. In the accompanying drawings, the dimensions of the structures are larger than actual sizes for clarity of the present disclosure. Terms used in the specification, “first”, “second”, etc., may be used to describe various components, but the components are not to be construed as being limited to the terms. These terms are used only for the purpose of distinguishing a component from another component. For example, without departing from the scope of the present disclosure, a first component may be referred as a second component, and a second component may be also referred to as a first component. As used herein, the singular forms “a”, “an”, and “the” are intended to include the plural forms as well unless the context clearly indicates otherwise. It will be further understood that the terms “comprises”, “includes”, or “has” when used in this specification specify the presence of stated features, regions, integers, steps, operations, elements and/or components, but do not preclude the presence or addition of one or more other features, regions, integers, steps, operations, elements, components and/or combinations thereof. It will also be understood that when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween. Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In certain preferred aspects, a vehicle may be electric-powered, including a hybrid vehicles, plug-in hybrids, or vehicles where electric power is the primary or sole power source.

Hereinafter, a method for manufacturing a self-standing film for a negative-electrode of a lithium secondary battery and a self-standing film for a negative-electrode of a lithium secondary battery manufactured using the method will be described in detail such that the skilled person to the art may easily implement the method and the self-standing film.

A method for manufacturing a self-standing film for a negative-electrode of a lithium secondary battery according to one embodiment of the present disclosure includes performing a first film formation process using a composition for forming the negative-electrode of the lithium secondary battery to obtain a first negative-electrode active material layer, wherein the composition includes a negative-electrode active material, a conductive material, and a binder; treating such as by pulverizing the first negative-electrode active material layer to obtain composite powders for formation of the negative-electrode as a pulverized product; and performing a second film formation process using the composite powders to obtain a second negative-electrode active material layer, wherein the binder includes a triblock copolymer having: a soft block derived from an aliphatic or cycloaliphatic diene-based monomer and having a rubber phase at room temperature; and a first hard block and a second hard block respectively connected to both ends of the soft block, and derived from an aromatic ring-containing ethylenically unsaturated monomer, and having a glass phase at room temperature.

The binder included in the composition for the formation of the negative-electrode before the first film formation process may be substantially spherical, and may have a spherical or substantially a spherical shape, and specifically, its average sphericity may be in a range of 0.7 to 1.0, preferably 0.8 to 1.0, more preferably 0.9 to 1.0. In other words, each of the binder particles in the composition for forming the negative-electrode of the lithium secondary battery before the first film formation process may be maintained substantially in the spherical shape and may be dispersed in the composition for formation of the negative-electrode.

In this regard, the sphericity of the binder may be derived as follows: major and minor diameters of 10 randomly selected particles may be measured using images of binder particles observed with a scanning electron microscope (SEM), and a ratio of the minor/major diameters of each particle may be obtained, and then, an average value of the ratios of the minor and major diameters may be defined as the sphericity. As the sphericity is closer to 1, a shape of the particle may be closer to the spherical shape.

The binder may include particles, each having an average diameter (D₅₀) in a range of 1 μm inclusive to 20 μm inclusive.

In this regard, the average diameter (D₅₀) of the binder refers to a diameter equivalent to a cumulative 50% of a cumulative volume distribution measured with a laser diffraction/scattering particle size distribution measuring device.

The soft block may contain a repeating unit derived from an aliphatic diene-based monomer and/or an alicyclic diene-based monomer and have a rubber phase at room temperature. Specifically, the soft block may be derived from an aliphatic or cycloaliphatic diene-based monomer including at least one selected from a group consisting of butadiene-based monomer, pentadiene-based monomer, and hexadiene-based monomer.

The butadiene-based monomer may include at least one selected from a group consisting of 1,2-butadiene, 1,3-butadiene, isoprene, and chloroprene.

The pentadiene-based monomer may include at least one selected from a group consisting of 1,2-pentadiene, 1,3-pentadiene, 1,4-pentadiene, 2,3-pentadiene, 2-methyl-1,3-pentadiene, 2-methyl-1,4-pentadiene, 2-methyl-2,3-pentadiene, 2-methyl-2,4-pentadiene, 3-methyl-1,3-pentadiene, 3-methyl-1,4-pentadiene, 4-methyl-1,3-pentadiene, 2-ethyl-1,3-pentadiene, 2-ethyl-1,4-pentadiene, 2-ethyl-2, 4-pentadiene, 3-ethyl-1,3-pentadiene, 3-ethyl-1,4-pentadiene, 4-ethyl-1,3-pentadiene, 1-chloro-1,3-pentadiene, 1-chloro-2,4-pentadiene, 2-chloro-1,3-pentadiene, 3-chloro-1,3-pentadiene, 3-chloro-1,4-pentadiene, and 5-chloro-1,3-pentadiene.

The hexadiene-based monomer may include at least one selected from a group consisting of 1,2-hexadiene, 1,3-hexadiene, 1, 4-hexadiene, 1, 5-hexadiene, 2, 3-hexadiene, 2, 4-hexadiene, 2,5-hexadiene, 3, 5-hexadiene, 2-methyl-1,3-hexadiene, 2-methyl-1,4-hexadiene, 2-methyl-1,5-hexadiene, 2-methyl-2,3-hexadiene, 2-methyl-2, 4-hexadiene, 3-methyl-1,2-hexadiene, 3-methyl-1, 3-hexadiene, 3-methyl-1,4-hexadiene, 3-methyl-1,5-hexadiene, 3-methyl-2,4-hexadiene, 3-methyl-2,5-hexadiene, 4-methyl-1,3-hexadiene, 4-methyl-1,4-hexadiene, 4-methyl-2,3-hexadiene, 5-methyl-1,3-hexadiene, 5-methyl-1,4-hexadiene, 2-ethyl-1,3-hexadiene, 2-ethyl-1,4-hexadiene, 3-ethyl-1,2-hexadiene, 3-ethyl-1,3-hexadiene, 3-ethyl-1,4-hexadiene, and 3-ethyl-1,5-hexadiene.

The triblock copolymer including the soft block has the characteristics of excellent flexibility, extrusion formability, and wear resistance.

The first hard block and the second hard block may contain a repeating unit derived from an ethylenically unsaturated monomer containing an aromatic ring, and have a glass phase at room temperature. Specifically, the aromatic ring contained in the ethylenically unsaturated monomer may be a substituted or unsubstituted benzene ring or a substituted or unsubstituted naphthalene ring.

Furthermore, the aromatic ring may be connected to a main chain or a side chain of the repeating unit of each of the first hard block and the second hard block, and may be preferably connected to the side chain of the repeating unit of each of the first hard block and the second hard block.

Each of the first hard block and the second hard block may independently be derived from an aromatic ring-containing ethylenically unsaturated monomer including at least one of a styrene-based monomer and an aromatic (meth)acrylic-based monomer.

The styrene-based monomer may include at least one selected from a group consisting of styrene, α-methylstyrene, p-methylstyrene, p-methoxystyrene, p-ethoxystyrene, t-butoxystyrene, p-acetoxystyrene, p-chlorostyrene, p-brom ostyrene, 2,4-dimethylstyrene, 3,5-dimethylstyrene and 2,4,6-trimethylstyrene.

The aromatic (meth)acrylic-based monomer may include at least one selected from a group consisting of benzyl acrylate, benzyl methacrylate, phenoxyacrylate, phenoxymethacrylate, phenyl acrylate, phenyl methacrylate, phenylethyl acrylate, and phenylethyl methacrylate.

Each of the first hard block and the second hard block may strongly bind to the negative-electrode active material or the conductive material via pi-pi interaction due to the aromatic ring structure included in the repeating unit thereof. Furthermore, each of the first hard block and the second hard block may form a crosslink due to physical bonding with a relatively low binding energy, and thus, may maintain a shape and a size thereof at a temperature below the glass transition temperature, while the forming thereof may be easy at a temperature above the glass transition temperature. Accordingly, when manufacturing the self-standing film for the negative-electrode at a temperature at which the triblock copolymer can be formed, the triblock copolymer may be flexibly deformed while each of the hard blocks included in the triblock copolymer maintains the bond with the negative-electrode active material or the conductive material. Thus, a binder portion may provide a physical cross-linking point in a linear form (discontinuous pillar or wire form), such that a solid three-dimensional network structure may be formed around the point.

Furthermore, the first hard block and the second hard block may impart high strength properties to the triblock copolymer containing the same.

In particular, the self-standing film for the negative-electrode of the lithium secondary battery according to one embodiment of the present disclosure may be obtained by performing the first film formation process using the composition for forming the negative-electrode of the lithium secondary battery to obtain the first negative-electrode active material layer, treating (e.g. pulverizing) the first negative-electrode active material layer to obtain the treated product as the composite powders, and performing the second film formation process using the composite powders to obtain the second negative-electrode active material layer. Thus, the self-standing film may implement stronger tensile strength compared to a self-standing film manufactured using a typical binder including the triblock copolymer including the first hard block and the second hard block. Thus, even when the binder of a low content, for example, having a lower limit of 5% by weight, a lower limit of 3% by weight, or a lower limit of 2% k by weight relative to a total weight of the composition for the formation of the negative-electrode is used, the self-standing film for the negative-electrode of the lithium secondary battery with excellent tensile strength is manufactured. In addition, the self-standing film for the negative-electrode is obtained using the composite powders including the treated (e.g. pulverized) product obtained by treating (e.g. pulverizing) the initially formed self-standing film for the negative-electrode. Thus, the dispersibility of the binder may be improved, and thus the flexibility of the manufactured self-standing film for the negative-electrode and the electrode including the same may be improved. Furthermore, this may increase the electrolyte stability of the manufactured lithium secondary battery.

A content of the first hard block and the second hard block may be in a range of 10 to 60%, preferably 15 to 55%, and more preferably 20 to 50%, based on a total content of the triblock copolymer. When the content of the first hard block and the second hard block satisfies the above numerical range, the bonding strength may be further improved due to strong interaction thereof with the negative-electrode active material or the conductive material, and the triblock copolymer may have appropriate flexibility and thus may have excellent formability.

A weight average molecular weight of each of the first hard block and the second hard block may be in a range of 9,000 g/mol inclusive to 20,000 g/mol inclusive, preferably 9,500 g/mol inclusive to 20,000 g/mol inclusive, more preferably 10,000 g/mol inclusive to 20,000 g/mol inclusive. When the weight average molecular weight of each of the first hard block and the second hard block satisfies the above numerical range, a physical cross-linking power may be improved, allowing a more stable three-dimensional network to be formed, and the processability may be further improved due to easy deformation in manufacturing the electrode.

Each of a first glass transition temperature and a second glass transition temperature corresponding to the first hard block and the second hard block, respectively, may be in a range of 50° C. inclusive to 120° C. inclusive. A third glass transition temperature corresponding to the soft block may be in a range of −120° C. inclusive to −50° C. inclusive. Preferably, each of the first glass transition temperature and the second glass transition temperature may be in a range of 80° C. inclusive to 120° C. inclusive, and the third glass transition temperature may be in a range of −120° C. inclusive to −80° C. inclusive. More preferably, each of the first glass transition temperature and the second glass transition temperature may be in a range of 80° C. inclusive to 110° C. inclusive, and the third glass transition temperature may be in a range of −110° C. inclusive to −80° C. inclusive. As the first hard block, the second hard block, and the soft block included in the triblock copolymer have the glass transition temperatures within the above numerical ranges, not only more reversible formation of the composition for the formation of the negative-electrode of the lithium secondary battery containing the binder including the triblock copolymer may be achieved, but also durability and flexibility of the electrode made of the above composition may be further improved and a shape thereof may be maintained more effectively.

The soft block, the first hard block, and the second hard block included in the triblock copolymer may not affect each other and may exhibit independent properties. Thus, the soft block may independently provide flexibility to the finally formed self-standing film for the negative-electrode of the lithium secondary battery, while the first hard block and the second hard block may independently provide the strong bonding force with the negative-electrode active material to the finally formed self-standing film for the negative-electrode of the lithium secondary battery. Furthermore, the soft block and the hard blocks have different glass transition temperatures. Thus, when the self-standing film for the negative-electrode is formed (via calendering, etc.) at a temperature above the glass transition temperature of the hard block, the formability of the triblock copolymer becomes good. Immediately after the film formation, exposure to a temperature below the glass transition temperature of the hard block and above the glass transition temperature of the soft block may allow the triblock copolymer to be flexible and maintain the high strength, so that the self-standing film for the negative-electrode of the lithium secondary battery including the triblock copolymer may not be easily broken by external stimuli.

The triblock copolymer is stable at a negative potential, so that occurrence of side reactions is suppressed. Thus, when the triblock copolymer is used as the binder for the negative-electrode of the lithium secondary battery, the lifespan characteristics of the electrode may be improved.

The negative-electrode active material may include at least one selected from a group consisting of carbon-based active material, silicon-based active material, metal-based active material capable of being alloyed with lithium, and lithium-containing active material.

The carbon-based active material may be, for example, graphite, hard carbon, soft carbon, or graphene. The graphite may be artificial graphite, natural graphite, a mixture of artificial graphite and natural graphite, natural graphite coated with artificial graphite, or a combination thereof.

The carbon-based active material has a small change in a crystal structure during intercalation/de-intercalation of lithium ions, thereby enabling continuous and repetitive redox reactions at the electrode, thereby realizing a lithium secondary battery with high capacity and better lifespan.

The silicon-based active material may be, for example, Si, SiOₘ, Si—C composite, Si-Q alloy, or a combination thereof, where m is 0<m≤0.2, and Q is an alkali metal, alkali earth metal, a group 13 to group 16 element, a transition metal, a rare earth element, or a combination thereof, and Si is excluded from Q.

The metal-based active material that can be alloyed with lithium may include, for example, B, Al, Ga, In, Ge, Sn, Pb, P, As, Sb, Bi, Mg, Ca, Zn, Cd, Pd, Ag, Au, Pt, alloys thereof, or oxides thereof.

The lithium-containing active material may be, for example, lithium-containing titanium complex oxide (LTO).

The conductive material may include at least one selected from a group consisting of graphite, activated carbon, carbon black, acetylene black, Ketjen black, carbon nanotubes, graphene, and carbon fiber.

The first film formation process may be performed in a dry manner. In other words, the composition for forming the negative-electrode of the lithium secondary battery used in the first film formation process may not substantially include a solvent. When the first film formation process is performed in a wet manner, there is a limitation in increasing a loading amount of the electrode due to the liquid slurry, and a network structure between the binder and the active material/conductive material cannot be formed. However, according to the present disclosure, the film formation process is performed in the dry manner, thereby enabling a great electrode loading amount that realizes a high energy density, and thereby manufacturing the lithium secondary batteries in which the network structure between the binder and the active material is formed more effectively.

The first film formation process may include calendering (rolling). In other words, the first negative-electrode active material layer may be formed by passing the composition for forming the negative-electrode of the lithium secondary battery, including the negative-electrode active material, the conductive material, and the binder between a pair of rolls and pressing and rolling the composition therebetween. In this regard, a diameter of the roll may be, for example, 50 to 1000 mm, preferably 100 to 1000 mm, and more preferably 100 to 500 mm.

The calendaring in the first film formation process may be performed at a temperature equal to or higher than the first glass transition temperature and the second glass transition temperature corresponding to the first hard block and the second hard block, respectively. Specifically, the calendaring may be carried out at 50 to 140° C., preferably at 80 to 140° C., and more preferably at 80 to 130° C. Accordingly, the formability of the triblock copolymer including the first hard block and the second hard block and the binder including the same may be further improved.

External forces such as shear force and tension force may be applied to the composition via the calendaring, thereby manufacturing the first self-standing film for the negative-electrode of the lithium secondary battery.

Specifically, the first negative-electrode active material layer manufactured in the dry manner may be a free-standing negative-electrode active material layer. The free-standing negative-electrode active material layer refers to a negative-electrode active material layer in a form of a thin film or film that maintains a certain shape by itself without being supported by another substrate. The free-standing negative-electrode active material layer may be manufactured in this way, such that a subsequent lamination process may proceed smoothly.

Next, the first negative-electrode active material layer formed in the first film formation process as described above is pulverized to obtain the composite powders for forming the negative-electrode.

The pulverization may be performed, for example, using a ball mill (a vibrating ball mill, a rotary ball mill, a planetary ball mill), a rod mill, a bead mill, a disk mill, a cutter mill, a hammer mill, an impeller mill, an extruder, a mixer (a high-speed rotating blade type mixer, homomixer), a homogenizer (a high pressure homogenizer, a mechanical homogenizer, an ultrasonic homogenizer), etc.

The composite powders for forming the negative-electrode obtained by pulverizing the first negative-electrode active material layer may have an ellipsoid shape, and its average sphericity may be in a range of 0.6 inclusive to 0.8 inclusive, preferably 0.65 inclusive to 0.75 inclusive, more preferably 0.67 inclusive to 0.73 inclusive. When the composite powder for forming the negative-electrode has the ellipsoid shape and its average sphericity satisfies the above numerical range, the second negative-electrode active material layer can be formed in the second film formation process.

The composite powders for forming the negative-electrode may include particles, each having an average diameter (D₅₀) in a range of 100 μm inclusive to 300 μm inclusive, preferably 120 μm inclusive to 280 μm inclusive, more preferably 140 μm inclusive to 260 μm inclusive.

In this regard, the average diameter (D₅₀) of the composite powder for the formation of the negative-electrode refers to a diameter equivalent to a cumulative 50% of a cumulative volume distribution measured with a laser diffraction/scattering particle size distribution measuring device.

Finally, the second film formation process is performed using the composite powders for forming the negative-electrode to form the second negative-electrode active material layer.

The second film formation process may be performed in a dry manner. That is, the composite powder for forming the negative-electrode used in the second film formation process may not substantially contain a solvent. Performing the second film formation process in the dry manner may allow a high electrode loading amount to be achieved, and a network structure between the binder and the active material or the conductive material to be formed more effectively.

The second film formation process may include calendering (rolling). That is, the second negative-electrode active material layer may be formed by passing the composite powders for forming the negative-electrode formed by pulverizing the first negative-electrode active material layer between the pair of rolls and pressing and rolling the composite powders therebetween. In this regard, a diameter of the roll may be, for example, in a range of 50 to 1000 mm, preferably 100 to 1000 mm, and more preferably 100 to 500 mm.

The calendering in the second film formation process may be performed at a temperature equal to or higher than the first glass transition temperature and the second glass transition temperature corresponding to the first hard block and the second hard block, respectively, as in the first film formation process. Specifically, the calendering may be carried out at 50 to 140° C., preferably at 80 to 140° C., and more preferably at 80 to 130° C. Accordingly, the formability of the triblock copolymer including the first hard block and the second hard block and the binder including the same may be further improved.

The second film formation process may be performed on the composite powders for forming the negative-electrode as obtained by pulverizing the first negative-electrode active material layer formed in the first film formation process. Thus, the dispersibility of the binder in the finally formed self-standing film for the negative-electrode may be further improved compared to that in the self-standing film for the negative-electrode formed simply via the first film formation process. Accordingly, a more rigid three-dimensional network structure, that is, a network structure in which the binder in a linear form (a discontinuous pillar or wire) connects the negative-electrode active materials or the conductive materials to each other may be formed.

According to another embodiment of the present disclosure, provided is a self-standing film for a negative-electrode of a lithium secondary battery, wherein the self-standing film includes a negative-electrode active material layer including a plurality of domains of a negative-electrode active material, a plurality of domains of a conductive material, and a binder, wherein the binder includes a triblock copolymer having: a soft block derived from an aliphatic or cycloaliphatic diene-based monomer and having a rubber phase at room temperature; and a first hard block and a second hard block respectively connected to both ends of the soft block, derived from an aromatic ring-containing ethylenically unsaturated monomer, and having a glass phase at room temperature, wherein the binder has a discontinuous pillar connecting one domain of the active material or one domain of the conductive material to another domain of the active material or another domain of the conductive material, wherein the binder has an average width perpendicular to a longitudinal direction thereof in a range of 10 nm inclusive to 150 nm inclusive.

The same contents as previously described in the method for manufacturing the self-standing film for the negative-electrode of the lithium secondary battery may be applied to the triblock copolymer including the soft block, the first hard block, and the second hard block.

One domain of the active material or one domain of the conductive material and another domain of the active material or another domain of the conductive material may be connected to each other via the binder in the form of the discontinuous pillar (or a wire) to form the three-dimensional network. In other words, the binder in the form of a non-continuous pillar (or wire) connects an outer surface of one domain of the active material or an outer surface of one domain of the conductive material with an outer surface of another domain of the active material or an outer surface of another domain of the conductive material to form a complex of the three-dimensional network structure in a net shape (the active material or the conductive material is located at an intersection and the linear binder connects them to each other). This three-dimensional network may be due to strong pi-pi interaction between the first hard block and the second hard block included in the triblock copolymer and the negative-electrode active material or the conductive material.

Specifically, in each of the first and second film formation processes, initially, contact occurs between the binder including the triblock copolymer and the negative-electrode active material or the conductive material due to high external force (shear force or tensile force, etc.). Afterwards, as the external force is lowered at an end of each of the first and second film formation processes, a distance between the binder and the negative-electrode active material or the conductive material increases, such that while the binder including the triblock copolymer in contact with the surface of the negative-electrode active material or the conductive material maintains the bond therewith, the shape of the binder may be flexibly deformed into the discontinuous pillar or wire form.

Furthermore, the triblock copolymer may change into the pillar shape under pressure at the temperature at which each of the first and second film formation processes is performed, thereby forming the three-dimensional network. As described above, the domain of the active material or the domain of the conductive material and the binder in the form of the discontinuous pillar may be connected to each other to form the three-dimensional network, thereby making it possible to manufacture the negative-electrode of the lithium secondary battery with excellent tensile strength.

In particular, the second film formation process may be performed on the composite powders for forming the negative-electrode as obtained by pulverizing the first negative-electrode active material layer formed in the first film formation process. Thus, the dispersibility of the binder in the finally formed self-standing film for the negative-electrode may be further improved compared to that in the self-standing film for the negative-electrode formed simply via the first film formation process. Accordingly, a more rigid three-dimensional network structure, that is, a network structure in which the binder in the linear form (a discontinuous pillar or wire) connects the negative-electrode active materials or the conductive materials to each other may be formed.

The binder may have the average width perpendicular to the longitudinal direction thereof in a range of 10 nm inclusive to 150 nm inclusive, preferably 50 nm inclusive to 140 nm inclusive, more preferably 70 nm inclusive to 120 nm inclusive, and most preferably 80 nm inclusive to 110 nm inclusive. When the average width perpendicular to the length direction of the binder satisfies the above numerical range, a dense three-dimensional network between the active materials, between the conductive materials, or between the active material and the conductive materials via the binder may be formed. Thus, the tensile strength and the flexibility of the manufactured self-standing film for the negative-electrode may be increased, and, further, excellent electrolyte stability may be achieved.

In this regard, the average width perpendicular to the longitudinal direction of the pillar-shaped binder included in the self-standing film may be derived as follows: a width perpendicular to the longitudinal direction at each of both ends and a center along the longitudinal direction of each of five randomly selected pillar binders was measured using the image of the binder particle observed with a scanning electron microscope (SEM), and an average value of these measured values is defined as the average width.

The average thickness of the self-standing film may be in a range of 30 μm inclusive to 500 μm inclusive, preferably 50 μm inclusive to 300 μm inclusive, more preferably 70 μm inclusive to 200 μm inclusive.

The tensile strength of the self-standing film may be in a range of 1 MPa inclusive to 2.0 MPa inclusive, preferably 0.7 MPa inclusive to 1.8 MPa inclusive, and more preferably 1.0 MPa inclusive to 1.6 MPa inclusive.

According to still another embodiment of the present disclosure, a negative-electrode for a lithium secondary battery including a current collector; and the self-standing film for the negative-electrode of the lithium secondary battery disposed on the current collector is provided.

When the self-standing film for the negative-electrode of the lithium secondary battery is formed via the first and second film formation processes, the self-standing film may be placed on the current collector and may be subjected to lamination. The lamination may be performed by a lamination roll, and in this regard, the lamination roll may be maintained at a temperature of 80° C. to 200° C. Via this lamination process, the self-standing film and current collector for the negative-electrode of the lithium secondary battery may be bonded to each other.

The current collector is not particularly limited as long as it has high conductivity without causing chemical changes in the battery. For example, stainless steel, aluminum, nickel, titanium, calcined carbon, copper, aluminum, or alloys thereof, or stainless steel having a surface treated with carbon, nickel, titanium, silver, etc. may be used as the current collector.

According to still another embodiment of the present disclosure, a lithium secondary battery including the negative-electrode for the lithium secondary battery; a positive-electrode for the lithium secondary battery; and an electrolyte is provided.

The positive-electrode for the lithium secondary battery may include at least one positive-electrode active material selected from a group consisting of lithium, nickel, cobalt, manganese, iron, tin, silicon, aluminum, and mixtures thereof. In a specific example, the positive-electrode active material such as LiCoO₂, LiMnO₂, LiFeO₂, Li(Ni_{0.6}Mn_{0.2}Co_{0.2})O₂, Li(Ni_{0.7}Mn_{0.15}Co_{0.15})O₂, Li(Ni_{0.8}Mn_{0.1}Co_{0.1}) O₂, Li(Ni_{0.9}Mn_{0.05}Co_{0.05})O₂, LiNi_{0.6}Co_{0.2}0Al_{0.02}O₂, LiNi_{0.7}Co_{0.2}0OAl_{0.02}O₂, LiNi_{0.8}Co_{0.15}Al_{0.05}O₂, LiNi_{0.85}Co_{0.01}Al_{0.05}O₂, LiNi_{0.86}Co_{0.1}Al_{0.02}O₂, LiMn₂O₄, LiFePO₄, etc. may be used for the positive-electrode for the lithium secondary battery.

The electrolyte may be a liquid electrolyte or a solid electrolyte.

When the electrolyte is the liquid electrolyte, the electrolyte may include lithium salt and a non-aqueous organic solvent.

The lithium salt may be applied without limitation as long as it is commonly used in the electrolyte of the lithium secondary batteries. For example, the lithium salt may include at least one compound selected from a group consisting of LiPF₆, LiBF₄, LiSbF₆, LiAsF₆, LiN(C₂F₅SO₂)₂, LiN(CF₃SO₂)₂, CF₃SO₃Li, LiC(CF₃SO₂)₃, LiC₄BO₈, LiTFSI, LiFSI and LiClO₄.

The non-aqueous organic solvent may include a type of organic solvent that may be used as a non-aqueous electrolyte in manufacturing the conventional lithium secondary battery. In this regard, a content thereof may also be appropriately changed within a generally usable range.

Specifically, the non-aqueous organic solvent may include common organic solvents that may be used as non-aqueous organic solvents for lithium secondary batteries, such as cyclic carbonate solvents, linear carbonate solvents, ester solvents, or ketone solvents. The common organic solvents may be used alone as well as in a mixture of at least two species thereof.

The cyclic carbonate solvent may include at least one selected from a group consisting of ethylene carbonate (EC), vinylene carbonate (VC), fluoroethylene carbonate (FEC), propylene carbonate (PC), and butylene carbonate (BC).

The linear carbonate solvent may include at least one selected from a group consisting of dimethyl carbonate (DMC), diethyl carbonate (DEC), dipropyl carbonate (DPC), ethylmethyl carbonate (EMC), methylpropyl carbonate (MPC), and ethylpropyl carbonate (EPC).

The ester solvent may include at least one selected from a group consisting of methyl acetate, ethyl acetate, propyl acetate, methyl propionate, ethyl propionate, γ-butyrolactone, γ-valerolactone, γ-caprolactone, δ-valerolactone and α-caprolactone.

Polymethylvinyl ketone, etc. may be used as the ketone solvent.

When the electrolyte is the liquid electrolyte, the lithium secondary battery may further include a separator.

The separator may include one or a stack of commonly used porous polymer films, for example, porous polymer films respectively made of polyolefin-based polymers such as ethylene homopolymer, propylene homopolymer, ethylene/butene copolymer, ethylene/hexene copolymer, and ethylene/methacrylate copolymer. Alternatively, a typical porous nonwoven fabric, for example, a nonwoven fabric made of high melting point glass fibers or polyethylene terephthalate fibers may be used as the separator. However, the present disclosure is not limited thereto. Furthermore, the separator coated with a ceramic component or a polymer material may be used to ensure heat resistance or mechanical strength. Optionally, the separator may have a single-layer or multi-layer structure.

In this regard, a pore diameter of the porous separator may be generally in a range of 0.01 to 50 μm, and a porosity thereof may be in a range of 5 to 95%. Furthermore, a thickness of the porous separator may generally range from 5 to 300 μm.

In one example, when the electrolyte is the solid electrolyte, the electrolyte may be a polymer-based solid electrolyte, an oxide-based solid electrolyte, a sulfide-based solid electrolyte, or a mixture thereof.

The polymer solid electrolytes may include, for example, polyether-based polymers, polycarbonate-based polymers, acrylate-based polymers, polysiloxane-based polymers, phosphazene-based polymers, polyethylene derivatives, alkylene oxide derivatives such as polyethylene oxide, phosphate ester polymer, poly agitation lysine, polyester sulfide, polyvinyl alcohol, polyvinylidene fluoride and its derivatives, polymers containing ionic dissociation groups, etc. Furthermore, the polymer electrolyte may include, as a polymer resin, a branched copolymer in which amorphous polymers such as PMMA, polycarbonate, polysiloxane, and/or phosphazene are copolymerized with a PEO (polyethylene oxide) main chain, a comb-like polymer, and a cross-linked polymer resin, etc. The polymer electrolyte may include as least one type thereof. The oxide-based solid electrolyte may include, for example, LLZO-based compounds, LLTO-based compounds such as Li₃ₓLa_{2/3-x}TiO₃, LISICON-based compounds such as Li₄Zn(GeO₄)₄, LATP-based compounds such as Li_{1.3}Al_{0.3}Ti_{1.7}(PO₄)₃, LAGP-based compounds such as (Li₁₊ₓGe₂₋ₓAlₓ(PO₄)₃), and LIPON-based compounds, etc. However, the present disclosure is not particularly limited thereto.

The sulfide-based solid electrolyte may include at least one of Li₆PS₅Cl, Li₂S—P₂S₅, Li₂S—LiI—P₂S₅, Li₂S—LiI—Li₂O—P₂S₅, Li₂S—LiBr—P₂S₅, Li₂S—Li₂O—P₂S₅, Li₂SLi₃PO₄—P₂S₅, Li₂S—P₂S₅—P₂O₅, Li₂S—P₂S₅—SiS₂, Li₃S—P₂S₅—SnS, Li₂S—P₂S₅—Al₂S₃, Li₃S—GeS₂ or Li₂S—GeS₂—ZnS. However, the present disclosure is not particularly limited thereto.

Hereinafter, the present disclosure is described in more detail based on Examples. However, these Examples are only intended to help understand the present disclosure, and the scope of the present disclosure is not limited to these Examples in any way.

### <Present Example 1> Manufacturing 1 of Self-Standing Film for Negative-Electrode

First, graphite as a negative-electrode active material, carbon as a conductive material, and SBS triblock copolymer (glass transition temperature of polystadien block: 100° C., glass transition temperature of polybutadiene block: −100° C.) as a binder were mixed with each other at a mass ratio of 96:1:3 without a solvent. The mixed powders were rolled using a two-roll press heated to 120° C. to manufacture a self-standing film for a negative-electrode.

The self-standing film for the negative-electrode formed through the above film formation process was pulverized using a pulverizer capable of applying a transfer force thereto, and the mixed powder as the pulverization product was put back into an rolling mill and a temperature is raised to 100° C. or higher to form a film.

### <Present Example 2> Manufacturing 2 of Self-Standing Film for Negative-Electrode

A self-standing film for a negative-electrode was manufactured in the same manner as Present Example 1, except that graphite, conductive material, and binder were mixed with each other at a mass ratio of 97:1:2.

### <Present Example 3> Manufacturing 3 of Self-Standing Film for Negative-Electrode

A self-standing film for a negative-electrode was manufactured in the same manner as Present Example 1, except that graphite, conductive material, and binder were mixed with each other at a mass ratio of 95:1:4.

### <Reference Example 1> Manufacturing 4 of Self-Standing Film for Negative-Electrode

First, graphite as a negative-electrode active material, carbon as a conductive material, and SBS triblock copolymer as a binder (glass transition temperature of polystadien block: 100° C., glass transition temperature of polybutadiene block: −100° C.) were mixed with each other at a mass ratio of 96:1:3 without a solvent. The mixed powder was rolled using a two-roll press heated to 120° C. to manufacture a self-standing film for a negative-electrode.

### <Reference Example 2> Manufacturing 5 of Self-Standing Film for Negative-Electrode

A self-standing film for a negative-electrode was manufactured in the same manner as Reference Example 1, except that graphite, conductive material, and binder were mixed with each other at a mass ratio of 97:1:2.

### <Reference Example 3> Manufacturing 6 of Self-Standing Film for Negative-Electrode

A self-standing film for a negative-electrode was manufactured in the same manner as Reference Example 1, except that graphite, conductive material, and binder were mixed with each other at a mass ratio of 95:1:4.

### <Experimental Example 1> SEM Image Observation of Composite Powder for Formation of Negative-Electrode

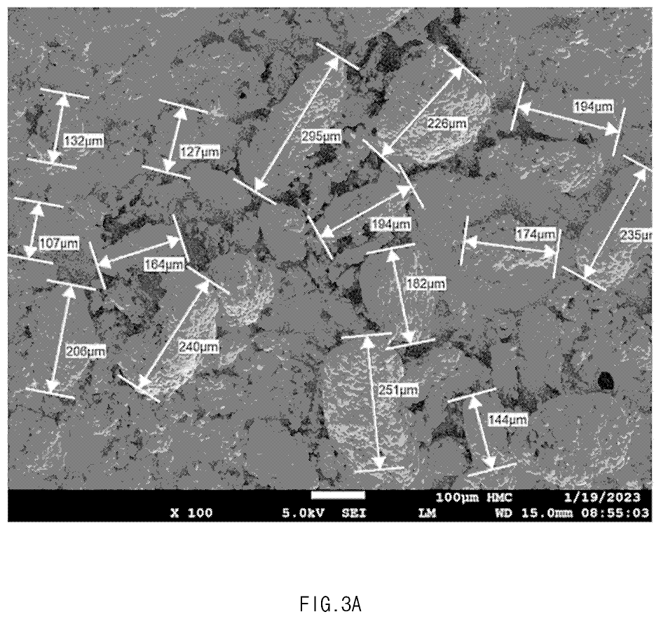

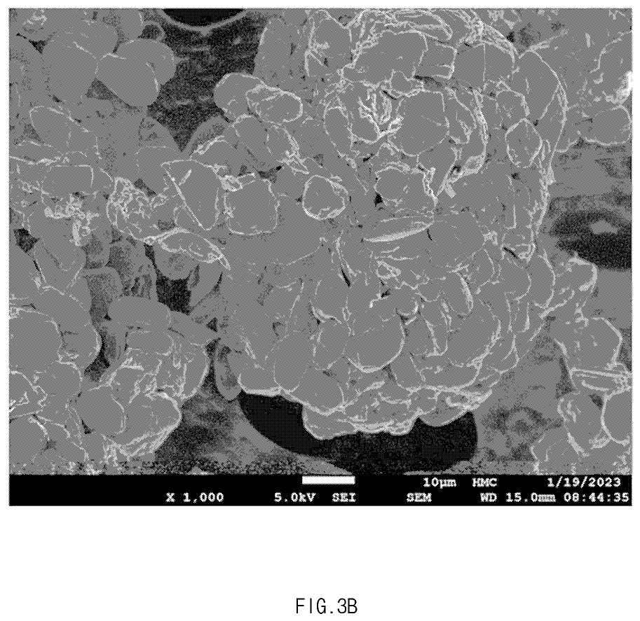

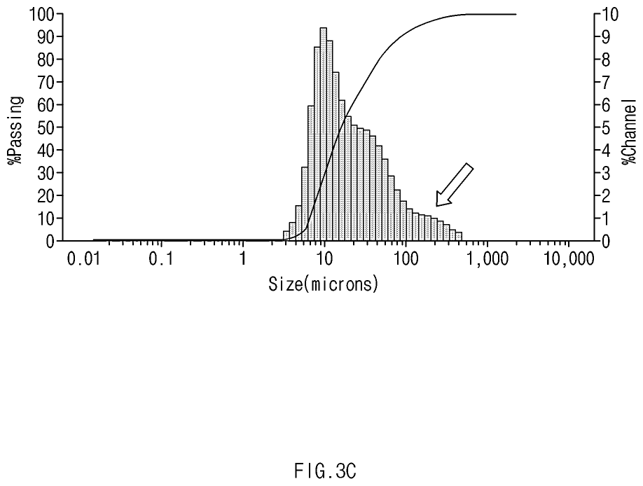

SEM images were taken of the mixed powder formed after the first film formation process and the pulverization in Present Example 1 and are shown in FIG. 3A and FIG. 3B.

The particles of the mixed powder formed after the pulverization had an oval shape of a composite obtained by the binder binding to the negative-electrode active material and the conductive material. The average sphericity thereof was in a range of 0.4 to 0.9, and a size thereof was in a range of 100 to 300 μm.

In one example, the particle analysis result of the mixed powder formed after the pulverization is shown in FIG. 3C. It may be identified that the composite powder in which the binder binds to the negative-electrode active material and the conductive material to form a composite is distributed in a range of 100 to 500 μm.

### <Experimental Example 2> SEM Image Observation of Self-Standing Film for Negative-Electrode

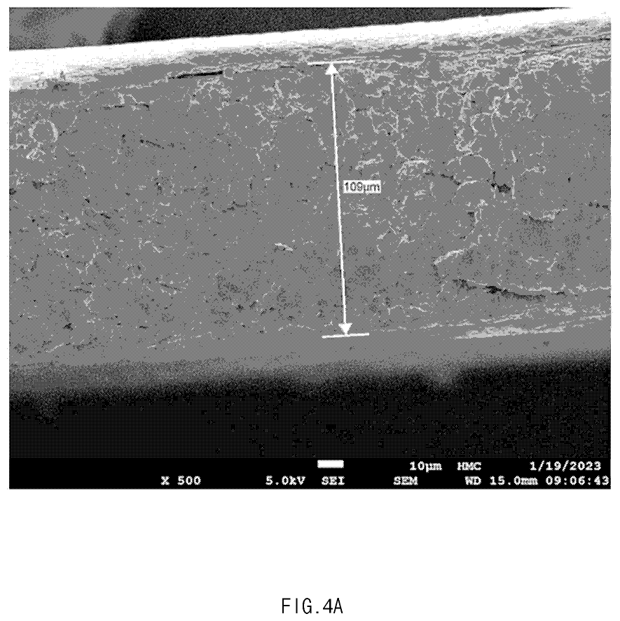

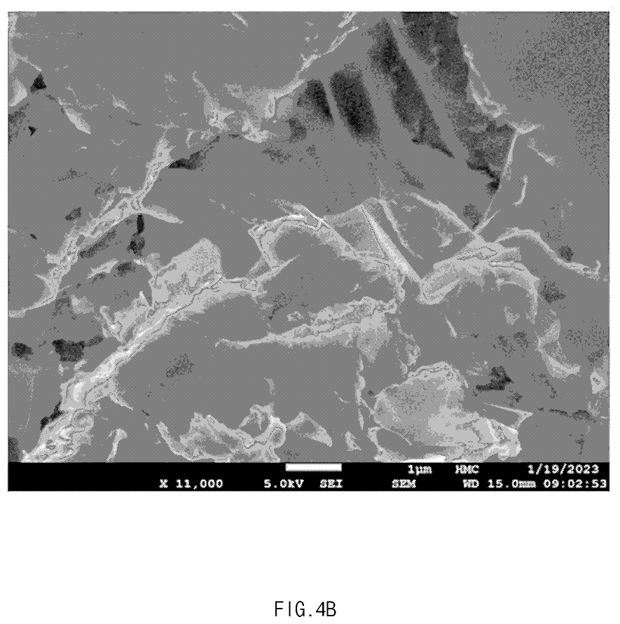

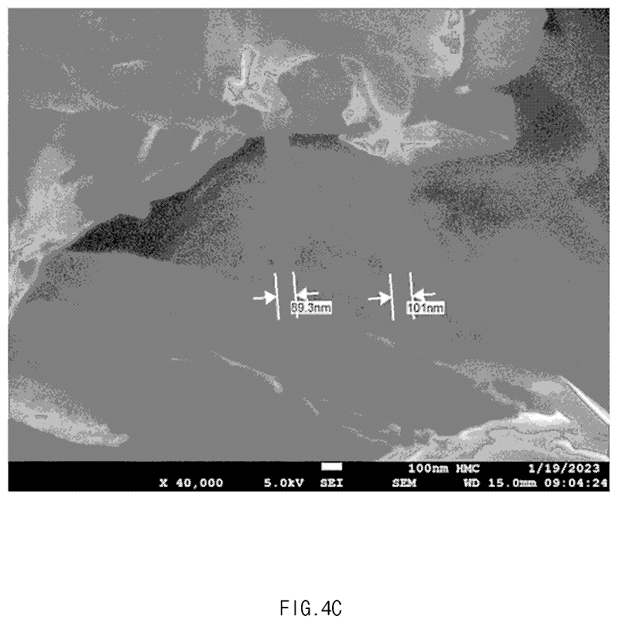

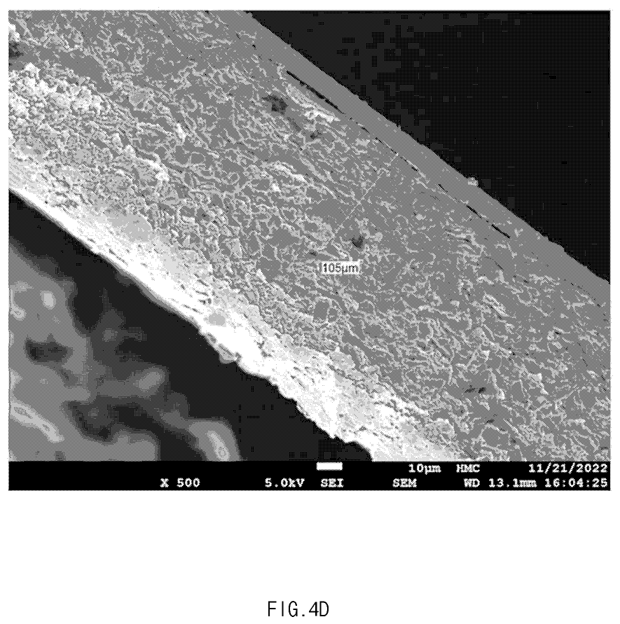

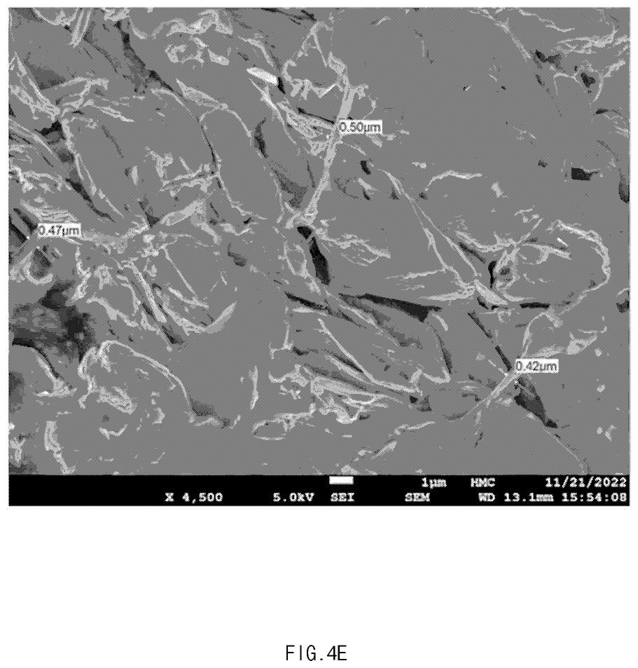

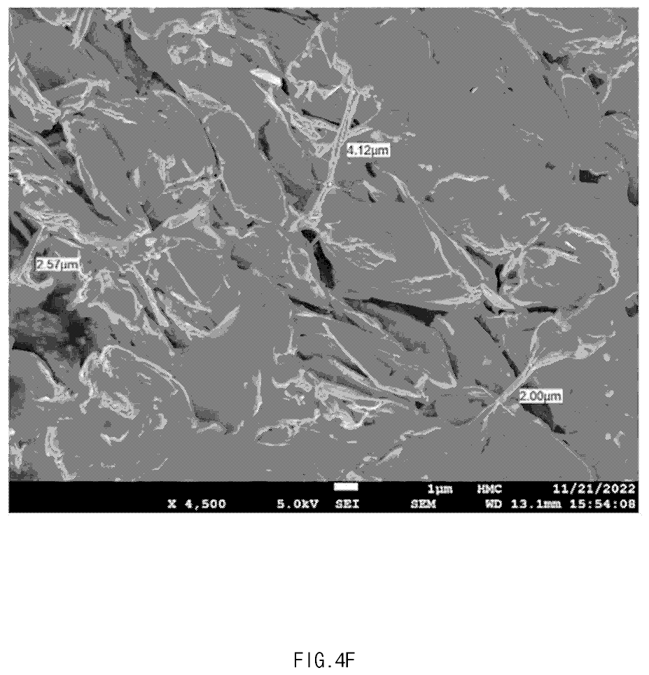

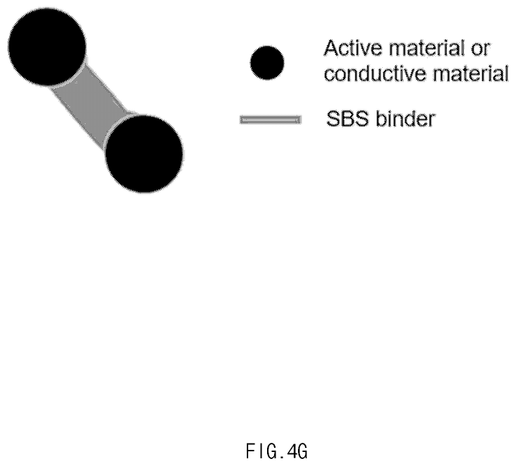

SEM images were taken of the self-standing film for the negative-electrode manufactured according to Present Example 1 and are shown in FIG. 4A to FIG. 4C. Further, the SEM images of the self-standing film for the negative-electrode in Reference Example 1 in which only one film formation process is performed, rather than “the film formation process—the pulverization—the film formation process” as in Present Example 1 were taken and are shown in FIG. 4D to FIG. 4F.

Referring to FIG. 4A, it was identified that the thickness of the self-standing film for the negative-electrode formed through the film formation process—the pulverization—the film formation process was about 109 μm.

Referring to FIG. 4B and FIG. 4C, it was identified that after “the film formation process—the pulverization—the film formation process”, the SBS binder of the pillar shape is connected to and disposed between the negative-electrode active materials, between the conductive materials, and between the negative-electrode active material and the conductive material to form the network structure, and the average width perpendicular to the longitudinal direction of the SBS binder of the pillar shape was about 80 to 110 nm.

On the contrary, referring to FIG. 4D, it was identified that a thickness of the self-standing film for the negative-electrode according to Reference Example 1 formed via only one film formation process was about 105 μm.

Referring to FIG. 4E and FIG. 4F, it is identified that when the film formation process is performed only once (Reference Example 1), the SBS binder of the pillar shape is connected to and disposed between the negative-electrode active materials, between the conductive materials, and between the negative-electrode active material and the conductive material to form the network structure as in Present Example 1, whereas the average width perpendicular to the length direction of the SBS binder of the pillar shape is about 0.4 to 0.5 μm, which is larger than that of Present Example 1.

In particular, it was identified that in the case of Present Example 1, the larger number of pillar-shaped binders connecting the negative-electrode active material and/or conductive materials to each other was present.

Summarizing the above results, under the film formation process, the binder of the pillar shape is connected to and disposed between the negative-electrode active materials, between the conductive materials, and between the negative-electrode active material and the conductive material to form the network structure. When the first film formation process, the pulverization, and the second film formation process are sequentially carried out, a more dense three-dimensional network structure may be formed due to the additional film formation process while a certain amount of the three-dimensional network structure has been formed.

FIG. 4G schematically shows the pillar-shaped SBS binder that connects the negative-electrode active materials or the conductive materials to each other in the network structure of the self-standing film for the negative-electrode as manufactured according to each of Present Example 1 and Reference Example 1. In other words, it may be identified that the discontinuous SBS binder in the form of the pillar point-contacts the outer surface of each of the active material domain and the conductive material domain, and connects the negative-electrode active materials or the conductive materials to each other.

### <Experimental Example 3> Measurement of Electrolyte Stability of Self-Standing Film for Negative-Electrode

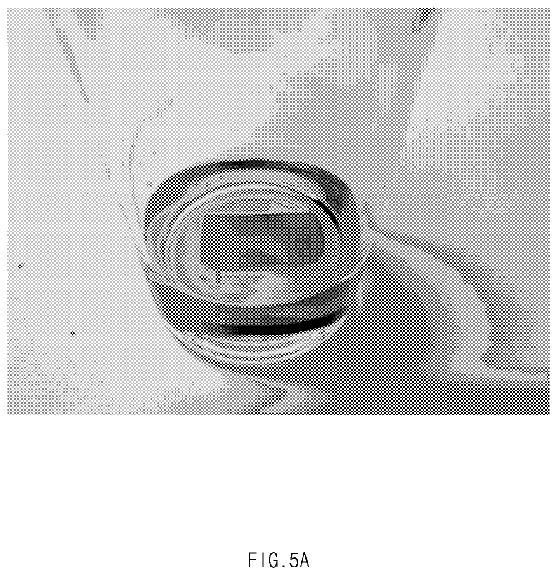

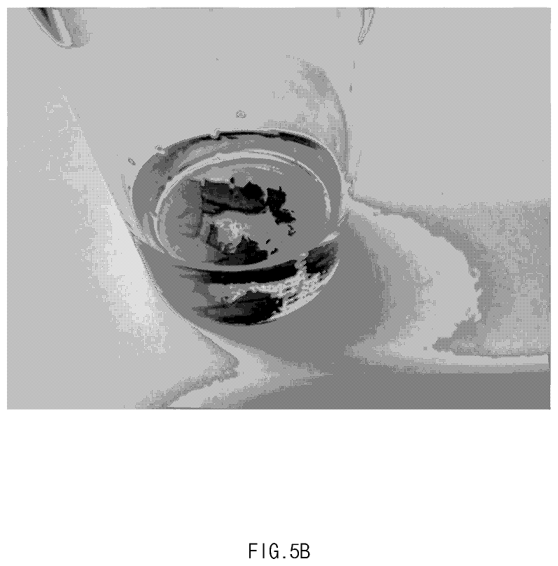

We soaked the self-standing film for the negative-electrode according to each of Present Example 1 and Reference Example 1 in an electrolyte solution for 1 minute, and then applied an impact to a vial containing therein the electrolyte solution 10 times using a rubber mallet, and then visually observed the change in appearance thereof. The results are shown in FIG. 5A and FIG. 5B.

As a result of the experiment, it was identified that the self-standing film for the negative-electrode according to Present Example 1 maintained its initial shape after the application of the impact thereto, while the self-standing film for the negative-electrode according to Reference Example 1 failed to maintain its initial shape after the application of the impact thereto, and thus was completely disintegrated.

The electrolyte stability of the self-standing film for the negative-electrode according to Present Example 1 is achieved due to the more rigid three-dimensional network between the binder and the negative-electrode active material or the conductive material as obtained by performing the film formation process, the pulverization and then, the additional film formation process.

### <Experimental Example 4> Measurement of Tensile Strength and Flexibility of Self-Standing Film for Negative-Electrode

First, the tensile strength of the self-standing film for the negative-electrode manufactured according to each of Present Example 1 to Present Example 3 and Reference Example 1 to Reference Example 3 was evaluated. A sample was prepared by punching each self-standing film into a size of 2 cm wide and 6 cm long, and the tensile strength thereof was measured at a speed of 5 mm/min of the UTM equipment.

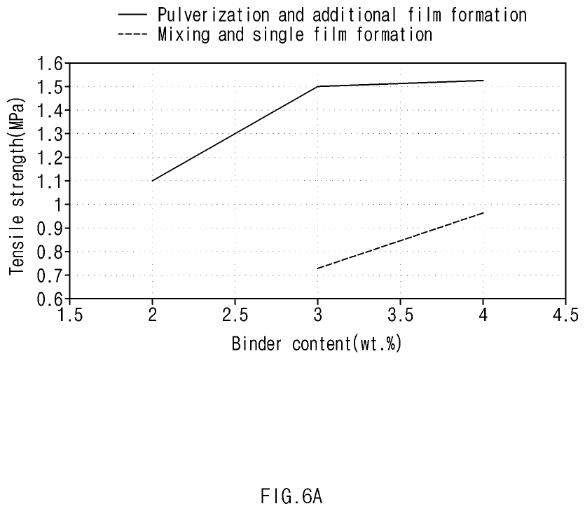

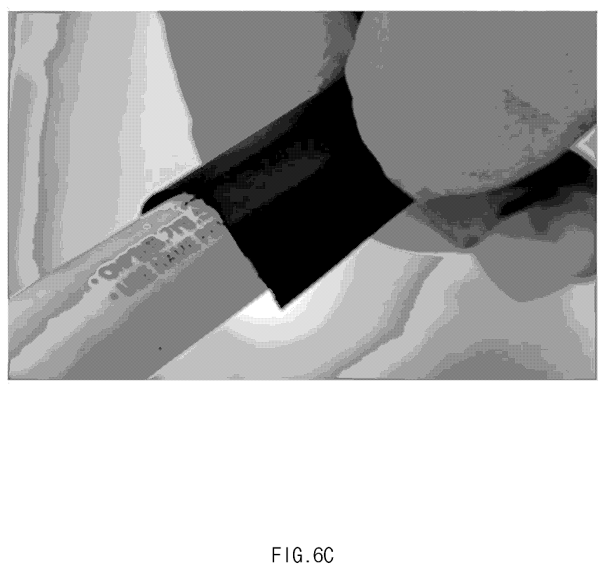

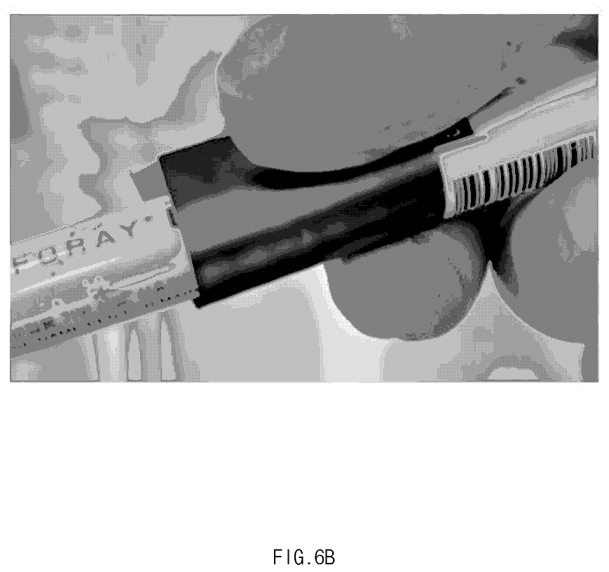

Referring to FIG. 6A, it may be identified that when the binder content is constant, Present Example 1 or 3 in which the pulverization and the additional film formation process are carried out has a higher tensile strength than that in Reference Example 1 or 3 in which only a single film formation process was carried out (Present Example 1> Reference Example 1, Present Example 3> Reference Example 3). This is because a process of the “film formation process-pulverization-film formation process” allows the network formed by the SES binder connecting the negative-electrode active materials, the conductive materials, or the negative-electrode active material and the conductive material to each other to be formed more rigidly, compared to the single film formation process.

Furthermore, in Reference Example 2, the film can be formed with the binder content of 2% by mass, while the tensile strength of the formed self-standing film is so weak that the measurement of the tensile strength is impossible. However, in the case of Present Example 2 in which the first film formation process, the pulverization, and the second film formation are carried out, the film can be formed with the binder content of 2% by mass.

Next, the flexibility in each of MD and TD directions of the self-standing film for the negative-electrode manufactured according to each of Present Example 1, Present Example 2, Reference Example 1, and Reference Example 2 was evaluated. The flexibility was evaluated based on whether or not cracks occurred when a name pen was wrapped with each self-standing film for the negative-electrode. FIG. 6B and FIG. 6C represent the experimental process for evaluating the flexibility in each of the MD and TD directions of the self-standing film for the negative electrode manufactured according to Present Example 1.

When comparing Present Example 1 and Reference Example 1 where the binder content is 3% by mass with each other, the self-standing film for the negative-electrode of Present Example 1 that has been subjected to the pulverization process is flexible in both the MD and TD directions, whereas the self-standing film for the negative-electrode of Reference Example 1 that was not subjected to the pulverization process was flexible in the MD direction, but had cracks in the TD direction.

Furthermore, when comparing Present Example 2 and Reference Example 2 where the binder content is 2% by mass with each other, the self-standing film for the negative-electrode of Present Example 2 that has been subjected to the pulverization process is flexible in both the MD and TD directions, whereas the self-standing film for the negative-electrode of Reference Example 2 that was not subjected to the pulverization process had substantially no flexibility and very weak basic tensile strength, and thus the evaluation thereof was impossible.

### <Present Example 4> Manufacturing 1 of Lithium Secondary Battery

The self-standing film for the negative-electrode according to Present Example 3 was placed on one surface of a copper foil coated with a primer layer, and was subjected to lamination using a lamination roll maintained at 120° C. to manufacture the negative-electrode of the lithium secondary battery.

The manufactured negative-electrode, lithium metal as the positive-electrode, and electrolyte in which 1M of LiPF₆, 2% by weight of vinylene carbonate (VC), and 1% by weight of LiPO₂F₂ were mixed with each other in a solvent in which EC:EMC:DEC were mixed with each other at a volume ratio of 5:9:6 were used to manufacture a coin-type half cell.

### <Reference Example 4> Manufacturing 2 of Lithium Secondary Battery

A coin-type half cell was manufactured in the same manner as Present Example 4, except that the self-standing film for the negative-electrode according to Reference Example 1 was used instead of the self-standing film for the negative-electrode according to Present Example 3.

### <Experimental Example 5> Performance Evaluation of Lithium Secondary Battery

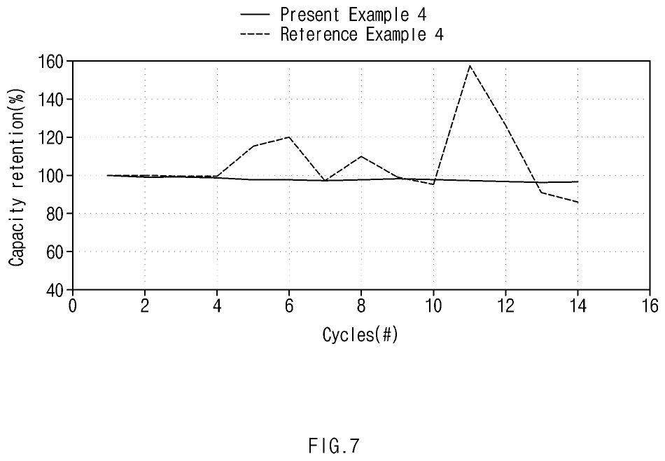

One cycle was performed on the lithium secondary battery according to each of Present Example 4 and Reference Example 4 at a rate of 0.1 C-rate, and the charging capacity and discharging capacity were measured and are shown in a following Table 1 and FIG. 7.

It was identified that as the cycle progressed, the capacity of the lithium secondary battery according to Present Example 4 remained stable, while the capacity of the lithium secondary battery according to Reference Example 4 became unstable. This is because the lithium secondary battery according to Present Example 4 had the improved tensile strength and flexibility of the electrode, and the improved electrolyte stability due to the negative-electrode including the self-standing film for the negative-electrode formed through the film formation-pulverization-film formation process.

TABLE 1

| | | Charge | Discharge | | |
|---|---|---|---|---|---|
| | Loading | Capacity | Capacity | Efficiency | Cell |
| Examples | (mg/cm²) | (mAh/g) | (mAh/g) | (%) | Durability |
| Present | 20.2 | 378.6 | 325.4 | 86 | Excellent |
| Example 4 | | | | | |
| Reference | 19.8 | 396.0 | 331.1 | 84.2 | Defective |
| Example 4 | | | | | |

Using the method for manufacturing the self-standing film for the negative-electrode of the lithium secondary battery in accordance with the present disclosure, the binder may bind to the negative-electrode active material or the conductive material via the strong interaction therewith, and thus, the self-standing film for the negative-electrode of the lithium secondary battery which is electrochemically stable even at the negative potential, and has excellent tensile strength and has good formability may be manufactured.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A method for manufacturing a self-standing film suitable for a negative-electrode of a lithium secondary battery, the method comprising:
forming a first electrode active film material using a composition that comprises i) a negative-electrode active material, ii) a conductive material, and iii) a binder;
treating the first electrode active material to obtain composite powders; and
forming a second electrode active film material using the composite powders,
wherein the iii) binder comprises a triblock copolymer comprising:
a) a soft block derived from an aliphatic or cycloaliphatic diene-based monomer and having a rubber phase at room temperature; and
b) a first hard block and a second hard block respectively connected to both ends of the soft block, and derived from an aromatic ring-containing ethylenically unsaturated monomer, and having a glass phase at the room temperature.

2. The method of claim 1, wherein the composite powders comprise powder elements that each has an ellipsoid shape, and an average sphericity thereof is in a range of 0.6 to 0.8.

3. The method of claim 1, wherein the composite powders comprise particles each having an average diameter (D50) in a range of 100 μm to 300 μm.

4. The method of claim 1, wherein the binder comprises particles having a spherical shape, and an average sphericity thereof is in a range of 0.8 to 1.0.

5. The method of claim 1, wherein the binder comprises particles, each having an average diameter (D₅₀) in a range of 1 μm to 20 μm.

6. The method of claim 1, wherein each of first and second glass transition temperatures corresponding to the first hard block and the second hard block, respectively, is in a range of 50° C. to 120° C., wherein a third glass transition temperature corresponding to the soft block is in a range of −120° C. to −50° C.

7. The method of claim 1, wherein the soft block is derived from the aliphatic or cycloaliphatic diene-based monomer including at least one selected from a group consisting of butadiene-based monomer, pentadiene-based monomer, and hexadiene-based monomer.

8. The method of claim 1, wherein each of the first hard block and the second hard block is independently derived from the aromatic ring-containing ethylenically unsaturated monomer including at least one of a styrene-based monomer and an aromatic (meth)acrylic-based monomer.

9. The method of claim 1, wherein at least one of the of 1) forming a first electrode active film material and 2) forming a second electrode active film material includes calendaring,
wherein the calendering is performed at a temperature equal to or higher than a first glass transition temperature and a second glass transition temperature corresponding to the first hard block and the second hard block, respectively.

10. A self-standing film suitable for a negative-electrode of a lithium secondary battery, the self-standing film comprising:
a negative-electrode active material layer that comprises a plurality of domains of a negative-electrode active material, a plurality of domains of a conductive material, and a binder,
wherein the binder includes a triblock copolymer having:
a soft block derived from an aliphatic or cycloaliphatic diene-based monomer and having a rubber phase at room temperature; and
a first hard block and a second hard block respectively connected to both ends of the soft block, derived from an aromatic ring-containing ethylenically unsaturated monomer, and having a glass phase at room temperature,
wherein the binder has a discontinuous pillar connecting one domain of the active material or one domain of the conductive material to another domain of the active material or another domain of the conductive material,
wherein the binder has an average width perpendicular to a longitudinal direction thereof in a range of 10 nm to 150 nm.

11. The self-standing film of claim 10, wherein the domain of the active material or the domain of the conductive material and the binder in the form of the discontinuous pillar are connected to each other to form a three-dimensional network.

12. The self-standing film of claim 10, wherein the binder has the average width perpendicular to the longitudinal direction thereof in a range of 70 nm inclusive to 120 nm inclusive.

13. The self-standing film of claim 10, wherein each of a first glass transition temperature and a second glass transition temperature corresponding to the first hard block and the second hard block, respectively is in a range of 50° C. to 120° C.,
wherein a third glass transition temperature corresponding to the soft block is in a range of −120° C. to −50° C.

14. The self-standing film of claim 11, wherein the soft block is derived from the aliphatic or cycloaliphatic diene-based monomer including at least one selected from a group consisting of butadiene-based monomer, pentadiene-based monomer, and hexadiene-based monomer.

15. The self-standing film of claim 10, wherein each of the first hard block and the second hard block is independently derived from the aromatic ring-containing ethylenically unsaturated monomer including at least one of a styrene-based monomer and an aromatic (meth)acrylic-based monomer.

16. The self-standing film of claim 10, wherein an average thickness of the self-standing film is in a range of 30 μm to 500 μm.

17. The self-standing film of claim 10, wherein a tensile strength of the self-standing film is in a range of 1.0 MPa inclusive to 2.0 MPa inclusive.

18. A negative-electrode for a lithium secondary battery comprising:
a current collector; and
a self-standing film for the negative-electrode of the lithium secondary battery disposed on the current collector, wherein the self-standing film includes the self-standing film for the negative-electrode of the lithium secondary battery of claim 10.

19. A lithium secondary battery comprising:
the negative-electrode of claim 18;
a positive-electrode; and
an electrolyte.

20. A vehicle comprising a lithium secondary battery of claim 19.
